(19) United States
(12) Patent Application Publication
(10) Pub. No.: US 2026/0222961 A1
(43) Pub. Date: Jul. 30, 2026

(54) METHOD AND APPARATUS FOR PROVIDING UE POLICY IN WIRELESS COMMUNICATION SYSTEM

(71) Applicant: Samsung Electronics Co., Ltd., Suwon-si, Gyeonggi-do (KR)

(72) Inventors: Dongyeon KIM, Suwon-si (KR); Jicheol LEE, Suwon-si (KR)

(21) Appl. No.: 19/146,155

(22) PCT Filed: Jan. 4, 2024
(86) PCT No.: PCT/KR2024/000151

§ 371 Date: Jul. 7, 2025

(30) Foreign Application Priority Data
Jan. 5, 2023 (KR) 10-2023-0001780
Dec. 29, 2023 (KR) 10-2023-0197620

(51) Int. Cl. H04W 40/02; H04W 76/10

(52) U.S. Cl. CPC H04W 40/02; H04W 76/10

(57) ABSTRACT

The present disclosure relates to a 5G or 6G communication system for supporting higher data transmission rates. Specifically, the present disclosure relates to a method and apparatus for providing UE policy in a wireless communication system.

### TECHNICAL FIELD

The disclosure relates to the field of communication and, specifically, to the operations of a UE, a base station, and a core network. In particular, the disclosure relates to a method and an apparatus for providing a UE policy in a wireless communication system.

### BACKGROUND ART

5G mobile communication technologies define broad frequency bands to enable high transmission rates and new services, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Embodiments set forth herein are to provide an apparatus and a method capable of effectively providing services in a wireless communication system.

### Solution to Problem

A method according to an embodiment of the disclosure may include receiving a first control signal transmitted from a base station, processing the received first control signal, and transmitting, to the base station, a second control signal generated based on the processing.

### Advantageous Effects of Invention

Embodiments set forth herein can effectively provide services in a wireless communication system.

### BRIEF DESCRIPTION OF DRAWINGS

FIG. 1 illustrates a network structure and interfaces of a 5G system according to an embodiment of the disclosure.

FIG. 2 illustrates a network structure and interfaces of a 5G system according to an embodiment of the disclosure.

FIG. 3 illustrates a network structure and interfaces of a 5G system according to an embodiment of the disclosure.

FIG. 4 illustrates a procedure for delivering and processing a UE policy in a 5G system according to an embodiment of the disclosure.

FIG. 5 is a block diagram illustrating a structure of a UE according to an embodiment of the disclosure.

FIG. 6 is a block diagram illustrating a structure of a base station according to an embodiment of the disclosure.

FIG. 7 is a block diagram illustrating a structure of a network entity according to an embodiment of the disclosure.

FIGS. 8A and 8B illustrate a procedure for transmitting and processing a UE policy in a 5G system according to an embodiment of the disclosure.

### MODE FOR THE INVENTION

In describing embodiments set forth herein, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

Hereinafter, exemplary embodiments of the disclosure will be described in detail with reference to the accompanying drawings. It should be noted that, in the accompanying drawings, the same or like elements are designated by the same or like reference signs as much as possible. Also, it should be noted that the following accompanying drawings of the disclosure are provided to help an understanding of the disclosure and the disclosure is not limited to configurations or arrangements illustrated in the drawings of the disclosure. In addition, a detailed description of known functions or configurations that may make the subject matter of the disclosure unclear will be omitted. It should be noted that, in the following description, only parts required to understand operations according to various embodiments will be described and a description of the other parts will be omitted so as not to make the subject matter of the disclosure obscure. Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications.

As used herein, each of such phrases as “A/B,” “A and/or B,” “A or B,” “at least one of A and B,” “at least one of A or B,” “A, B, or C,” “at least one of A, B, and C,” and “at least one of A, B, or C,” may include any one or all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

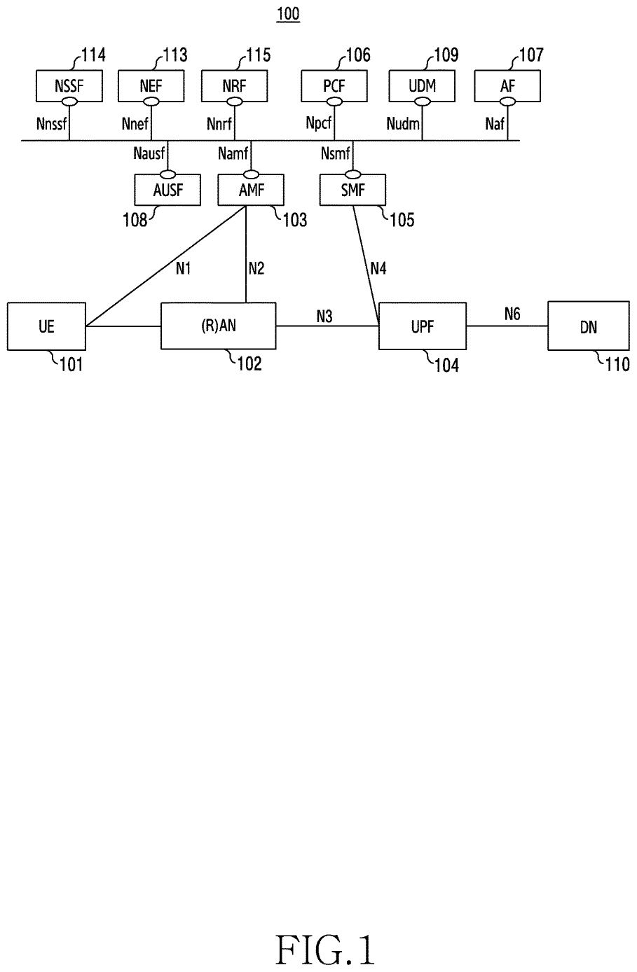

As used herein, network technology may refer to standard specifications (e.g., TS 23.501, TS 23.502, TS 23.503, etc.) defined by the international telecommunication union (ITU) or 3GPP, and each element included in a network structure of FIG. 1 may indicate a physical entity, or refer to software for performing individual functions or hardware combined with the software. In the drawings, reference numerals represented by “Nx”, such as N1, N2, N3, . . . , etc. indicate know interfaces between NFs in a 5G core network (CN).

According to an embodiment of the disclosure, in a 5G system, a network provides a UE route selection policy (URSP) to a UE that enables application traffic of the UE to be transmitted and received via an appropriate PDU session.

The URSP includes one or more URSP rules. The URSP rules may be composed of traffic descriptors (TDs) and route selection components (RSCs). When the UE detects an application or application traffic that corresponds to a traffic descriptor, the UE may associate the application traffic with a previously generated (or established) PDU session. Alternatively, when there is no PDU session that satisfies RSCs of the previously generated PDU session, the UE may establish a new PDU session.

When a traffic descriptor received from a network contains an application descriptor that identifies an application, the UE may use the application descriptor to associate an application or application traffic detected by the UE with a PDU session. In this case, the application descriptor may include an operating system ID (OS ID) and an operating system application ID (OS App ID), wherein OS ID and OS App ID values may be uniquely defined by an OS.

In a current 5G system, when a traffic descriptor received by the UE from a network is constructed based on an application descriptor including an OS ID and an OS App ID uniquely defined by an OS, and when the OS does not pass the OS ID and/or the OS App ID to a UE module for performing an operation of associating an application or application traffic detected by the UE with a PDU session, the application or the application traffic may not associated with the PDU session.

Accordingly, the disclosure provides a method and an apparatus for, when constructing a traffic descriptor for a URSP, using a traffic descriptor component, which is different from an application identifier uniquely defined by an internal module of the UE, and is capable of associating an application or application traffic of the UE with a PDU session.

FIG. 1 illustrates a network architecture and interfaces of a 5G system according to an embodiment of the disclosure.

Network entities included in the network architecture of the 5G system in FIG. 1 may include network functions (NFs), depending on the system implementation.

Referring to FIG. 1, a network architecture of a 5G system may include various network entities. For example, the 5G system may include an authentication server function (AUSF) 108, a (core) access and mobility management function (AMF) 103, a session management function (SMF) 105, a policy control function (PCF) 106, an application function (AF) 107, a unified data management (UDM) 109, a data network (DN) 110, a network exposure function (NEF) 113, a network slicing selection function (NSSF) 114, an edge application service domain repository (EDR) 113, an edge application server (EAS) (not shown), an EAS discovery function (EASDF) (not shown), a user plane function (UPF) 104, a (radio) access network (R) AN) 102, and a user equipment (UE) (or terminal) 101. The disclosure is not limited the above examples, and the 5G system may include more or fewer entities than the entities illustrated in FIG. 1.

According to an embodiment of the disclosure, the NFs in a 5G system may support the following functions. The disclosure is not limited to the following examples.

According to an embodiment of the disclosure, the AUSF 108 may process and store data for authentication of the UE 101.

According to an embodiment of the disclosure, the AMF 103 may provide a function for access and mobility management on a per-UE basis, and by default, one UE may be connected to one AMF. Specifically, the AMF 103 may support functions such as signaling between CN nodes for mobility between 3GPP access networks, radio access network (RAN) CP interface (i.e., N2 interface) termination, non-access stratum (NAS) signaling termination (N1), NAS signaling security (NAS ciphering and integrity protection), AS security control, registration management (registration area management), connection management, idle mode UE reachability (including control and execution of paging retransmission), mobility management control (subscription and policy), intra-system mobility and inter-system mobility support, support for network slicing, SMF selection, lawful intercept (LI) (for an AMF event and an interface to an LI system), delivery of session management (SM) message between the UE and the SMF, a transparent proxy for routing a session management (SM) message, access authentication, access authorization including roaming permission checking, delivery of an SMS message between the UE and a short message service function (SMSF), a security anchor function (SAF), and/or security context management (SCM). Some or all of the functions of the AMF 103 may be supported within a single instance of one AMF.

According to an embodiment of the disclosure, the DN 110 may represent, for example, an operator service, internet access, or third-party service. The DN 110 may transmit a downlink protocol data unit (PDU) to the UPF 104, or may receive, from the UPF 104, a PDU transmitted from the UE 101.

According to an embodiment of the disclosure, the PCF 106 may receive information about packet flows from an application server and provide functionality for determining policies such as mobility management and session management. Specifically, the PCF 106 may support functions such as supporting a unified policy framework for controlling network operations, providing policy rules so that control plane function(s) (e.g., AMF, SMF, etc.) can enforce the policy rules, and implementing a front end for accessing relevant subscription information for policy decisions in a user data repository (UDR).

According to an embodiment of the disclosure, the SMF 105 provides a session management function, and if the UE 101 has multiple sessions, each session may be managed by a different SMF. Specifically, the SMF 105 may support functions such as session management (e.g., establishment, modification, and release of a session, including maintenance of a tunnel between the UPF 104 and the (R) AN 102 node), assignment and management of UE IP addresses (optionally including authentication), selection and control of a user plane (UP) function, configuration of traffic steering to route traffic from the UPF 104 to appropriate destinations, and termination of interfaces toward policy control functions, enforcement of control parts of policy and quality of service (QoS), lawful intercept (LI) (for an SM event and an interface to an LI system), termination of SM parts of NAS messages, downlink data notification, delivery of access network (AN)-specific SM information to (R) AN 102 through N2 via an initiator (AMF 103), determination of a session and service continuity (SSC) mode, and a roaming function. Some or all of the functions of the SMF 105 may be supported within a single instance of one SMF.

According to an embodiment of the disclosure, the UDM 109 may store user subscription data, policy data, etc. The UDM 109 may include two parts, i.e., an application front end (FE) (not shown) and a user data repository (UDR) (UDR) (not shown).

According to an embodiment of the disclosure, the front end (FE) (not shown) may include a UDM FE responsible for location management, subscription management, credential processing, and the like, and a PCF responsible for policy control. The UDR may store data required for the functions provided by the UDM-FE and policy profiles required by the PCF. The data stored in the UDR may include policy data and user subscription data, including subscription identifiers, security credentials, access and mobility related subscription data, and session-related subscription data. The UDM-FE may access the subscription information stored in the UDR and support functions such as authentication credential processing, user identification handling, access authentication, registration/mobility management, subscription management, and SMS management.

According to an embodiment of the disclosure, the UPF 104 may deliver downlink PDUs received from the DN 110 to the UE 101 via the (R) AN 102, and may deliver uplink PDUs received from the UE 101 to the DN 110 via the (R) AN 102. Specifically, the UPF 104 may support functions such as an anchor point for intra- and inter-RAT mobility, an external PDU session point for interconnection to a data network, packet routing and forwarding, a user plane part of packet inspection and policy rule enforcement, lawful intercept, and traffic usage reporting, uplink classifier for supporting the routing of traffic flows to the data network, branching points for supporting multi-homed PDU sessions, QoS handling for a user plane (e.g., packet filtering, gating, uplink/downlink rate enforcement), uplink traffic verification (SDF mapping between service data flow (SDF) and QoS flow), transport-level packet marking within uplink and downlink, downlink packet buffering, and downlink data notification triggering. Some or all of the functions of the UPF 104 may be supported within a single instance of one UPF.

According to an embodiment of the disclosure, the AF 107 may interact with a 3GPP core network to provide services (e.g., to support functions such as application influence on traffic routing, access to network capability exposure, and interworking with a policy framework for policy control).

According to an embodiment of the disclosure, the (R) AN 102 refers to a new radio access network that supports both evolved E-UTRA, which is an evolved version of 4G radio access technology, and new radio (NR) technology (e.g., gNB).

According to an embodiment of the disclosure, a gNB may support radio resource management functions (e.g., radio bearer control, radio admission control, connection mobility control, dynamic allocation of resources to UEs on the uplink/downlink (i.e., scheduling)), internet protocol (IP) header compression, encryption and integrity protection of user data streams, selection of the AMF during UE attachment if routing to the AMF is not determined from information provided to the UE, routing of user plane data to UPF(s), routing of control plane information to the AMF, connection setup and release, scheduling and transmission of paging messages (originating from the AMF), scheduling and transmission of system broadcast information (originating from the AMF or operating and maintenance (O&M), measurement and measurement reporting configuration for mobility and scheduling, transport level packet marking in the uplink, session management, support for network slicing, QoS flow management and mapping to data radio bearers, support for UEs in inactive mode, NAS message distribution function, NAS node selection function, radio access network sharing, dual connectivity, and tight interworking between NR and E-UTRA.

According to an embodiment of the disclosure, the UE 101 may refer to a user equipment. The user equipment may be referred to as terms such as terminal, mobile equipment (ME), or mobile station (MS). Furthermore, the user equipment may be a portable device, such as a laptop, a mobile phone, a personal digital assistant (PDA), a smartphone, or a multimedia device, or may be a non-portable device, such as a personal computer (PC) or a vehicle-mounted device.

According to an embodiment of the disclosure, the NEF 111 may provide a means for securely exposing services and capabilities provided by 3GPP network functions, such as those for third parties, internal exposure/re-exposure, application functions, and edge computing. The NEF 111 may receive information (based on the exposed capability (capabilities) of the other NF(s)) from the other NF(s). The NEF 111 may store the received information as structured data by using a standardized interface to a data storage network function. The stored information may be re-exposed by the NEF 111 to other NF(s) and AF(s) and utilized for other purposes such as analysis.

According to an embodiment of the disclosure, the NRF 115 may support a service discovery function. The NRF 115 may receive an NF discovery request from an NF instance, and provide information about a discovered NF instance to the NF instance. Furthermore, the NRF 115 may maintain available NF instances and services supported by the NF instances.

According to an embodiment of the disclosure, FIG. 1 illustrates a reference model for a case where the UE 101 accesses one DN 110 by using one PDU session for ease of description, but the disclosure is not limited thereto.

The UE 101 may use multiple PDU sessions to access, for example, two (i.e., local and central) data networks simultaneously. In this case, two SMFs may be selected for different PDU sessions. However, each SMF may have the capability to control both a local UPF and a central UPF within a PDU session.

Furthermore, the UE 101 may simultaneously access, for example, two (i.e., local and central) data networks provided within a single PDU session.

According to an embodiment of the disclosure, the NSSF 114 may select a set of network slice instances for serving the UE 101. Furthermore, the NSSF 114 may determine a granted network slice selection assistance information (NSSAI) and, if necessary, perform a mapping to a subscribed single-network slice selection assistance information (S-NSSAI). In addition, the NSSF 114 may determine a configured NSSAI and, if necessary, perform mapping to subscribed S-NSSAIs. Furthermore, the NSSF 114 may determine a set of AMFs to be used to serve the UE or, depending on the configuration, may query the NRF 115 to determine a list of candidate AMFs.

According to an embodiment of the disclosure, the NRF 115 may support a service discovery function. The NRF 115 may receive an NF discovery request from an NF instance and provide information about a discovered NF instance to the NF instance. Furthermore, the NRF 115 may maintain available NF instances and services supported by the NF instances.

According to an embodiment of the disclosure, in 3GPP systems, conceptual links connecting NFs in the 5G system are defined as reference points. In the following, examples of reference points included in the 5G system architecture described in FIG. 1 are provided below.
N1: A reference point between a UE and an AMF
N2: A reference point between an (R) AN and an AMF
N3: A reference point between an (R) AN and a UPF
N4: A reference point between an SMF and a UPF
N5: A reference point between a PCF and an AF
N6: A reference point between a UPF and a data network
N7: A reference point between an SMF and a PCF
N8: A reference point between a UDM and an AMF
N9: A reference point between two core UPFs
N10: A reference point between a UDM and an SMF
N11: A reference point between an AMF and an SMF
N12: A reference point between an AMF and an AUSF
N13: A reference point between a UDM and an authentication server function (AUSF)
N14: A reference point between two AMFs
N15: A reference point between a PCF and an AMF for a non-roaming scenario, and a reference point between a PCF and an AMF in a visited network for a roaming scenario

In the following descriptions, a UE may refer to the UE 101, and the term “UE” or “terminal” may be used interchangeably. In this case, unless specially defined additionally, a UE may be understood as the UE 101.

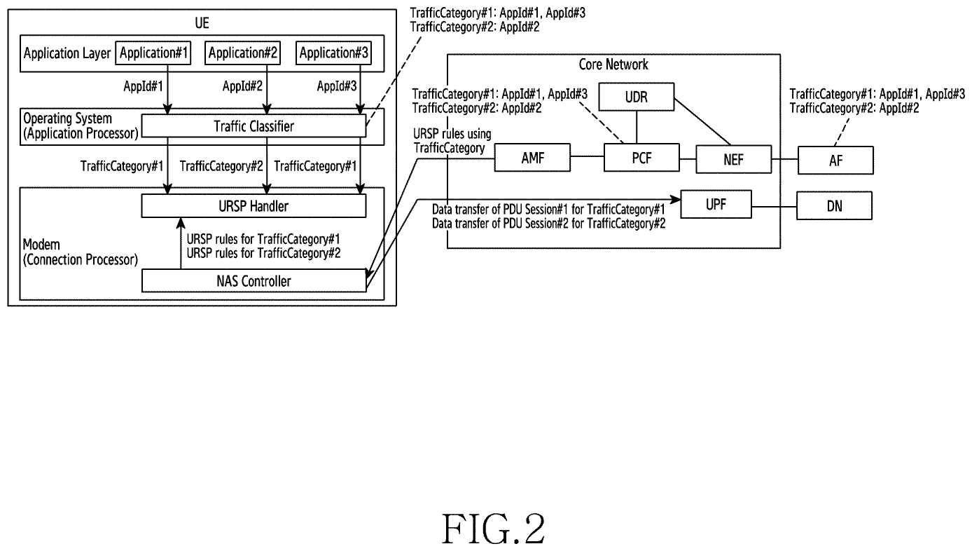

FIG. 2 illustrates a network architecture and an interface of a 5G system according to an embodiment of the disclosure. A UE and network entities in FIG. 2 may include the UE and network entities illustrated in FIG. 1, and the description of FIG. 1 may be omitted from the description in FIG. 2. FIG. 2 includes a UE policy processing procedure in which the UE's OS does not expose an identifier of an application being currently executed in a layer above the OS to a layer below the OS.

According to an embodiment of the disclosure, a UE route selection policy (URSP) is a piece of UE policy information provided by a PCF to the UE, may be used by the UE, and may be used to determine whether an application detected by the UE can be associated with an already established PDU session, can be offloaded to non-3GPP access that exists outside the PDU session, can be routed through a ProSe Layer-3 UE-to-Network Relay that exists outside the PDU session, or can be associated with a newly established PDU session. A URSP may include one or more URSP rules, and one URSP rule may include one rule precedence, one traffic descriptor, and one or more route selection descriptors.

Examples of a UE route selection policy (URSP) rule are as follows. However, the disclosure is not limited to the following examples
Rule Precedence: This is information about the precedence of a corresponding URSP rule. The precedence of the corresponding URSP rule may have a value different from those of other URSP rules.
Traffic Descriptor (TD): This may include traffic descriptor components for identifying a detected application or the traffic of the application. Specific examples are provided below.
   Application descriptor: This is information for referring to an application of a UE. For example, the application descriptor may include an APPID including an OSID and an OSAPPID.
   IP descriptor: This indicates an IP address that represents the destination address of an IP packet transmitted by a UE. The IP descriptor may include an IP 3-tuple, i.e., IP destination address, port number, and protocol.
   Domain descriptor: This expresses the destination address of a server, to which a UE is connected, in a fully qualified domain name (FQDN) format.
   Non-IP descriptor: This is information to designate the destination of non-IP data.
   DNN: This is a data network name.
   Connection Capability (CC): This is a type of information for specifying the characteristics of traffic being connected, and may have values such as IP multimedia subsystem (IMS), multimedia message service (MMS), and Internet.
List of Route Selection Descriptor: This may include one or more route selection descriptors.
Route Selection Descriptor Precedence: This is Information about the precedence of a corresponding RSD. The precedence of corresponding RSD may have a value different from those of other RSDs.
Route Selection Component (RSC): Specific examples are provided below.
   SSC Mode Selection: This is a component that specifies session and service continuity, and may have values such as SSC Mode 1, SSC Mode 2, SSC Mode 3, etc.
   Network Slice Selection: This is information for specifying a network slice.
   DNN Selection: This is a data network name.
   PDU Session Type Selection: This is a component for specifying a PDU-Session type, which can specify IPV4, IPV6, IPv4v6, Ethernet, or Non-IP.
   Non-Seamless Offload indication: This indicates that application traffic may be offloaded via non-3GPP access, which exists outside a PDU session.
   ProSe Layer-3 UE-to-Network Relay Offload indication: This indicates that application traffic may be offloaded via ProSe Layer-3 UE-to-Network Relay, which exists outside the PDU session.
   Access Type preference: This component indicates whether a PDU session is a PDU session connected via 3GPP access, is a session connected via non-3GPP access, or is a session that supports a multi-access connection using both 3GPP access and non-3GPP access.
   PDU Session Pair ID: This component indicates an identifier that application traffic is shared to a redundant PDU session.
   Redundancy Sequence Number (RSN): This component refers to an identifier used in redundant transmission.

Referring to FIG. 2, the UE may include an application layer, an operating system, and a modem. The UE may be connected to a core network through a control plane and a user plane. In the case of the control plane, the UE may be connected to an AMF via an RAN by using an N1 interface. For the user plane, the UE may be connected to a UPF via the RAN, and the RAN and the UPF may be connected to each other via an N3 interface. The UPF may be connected to a DN through an N6 interface.

The modem may operate on a connection processor. The modem may include a NAS controller and a URSP handler. A receiver of the modem may deliver, to the NAS controller, data that corresponds to a NAS message among data received from the core network.

According to an embodiment of the disclosure, the NAS controller may generate control plane data to be transmitted to the core network as a NAS message and provide the control plane data to a transmitter of the modem. The NAS controller may deliver, to the URSP handler, a UE policy (including URSP rules) and related information, provided by the PCF to the UE, among various types of NAS messages received from the core network. When the URSP handler specifies and notifies of a URSP rule for an application, the NAS controller may determine whether there is an existing PDU session to which the URSP rule is applied. When such a session exists, the NAS controller may perform a procedure to transmit/receive data through the PDU session, and when such a session does not exist, the NAS controller may perform a procedure to establish a new PDU session.

According to an embodiment of the disclosure, the URSP handler may store the UE policy (including URSP rules) and related information provided to the UE by the PCF, or when the core network requests UE policy and related information stored by the UE, may transmit the UE policy and the related information to the core network via the NAS controller. The URSP Handler may receive information that enables the OS to directly or indirectly identify an application executed in a layer above the OS, and may specify one URSP rule for the application from among one or more URSP rules received from the NAS controller. The OS may use an application ID and/or a traffic category as information that enables the OS to directly or indirectly identify the application. When an application ID is used, the URSP handler may also identify which applications are being executed on the UE at a specific time point. When a traffic category is used, the URSP handler may specify (or identify) one or more URSP rules for the traffic category. The traffic category may be an identifier that categorizes an application based on the application's service feature. For example, application(s) for an enterprise service may be categorized as “Enterprise,” application(s) for a gaming service that requires low-latency transmission may be categorized as “Gaming,” application(s) for a service that requires high-definition video streaming may be categorized as “Video Streaming,” and so on.

An application may be categorized into one or more traffic categories, and one or more applications may be categorized into one traffic category. A traffic category for any application may be provided as a piece of information that constitutes a traffic descriptor or a route selection component of a URSP rule. For example, a traffic category may be defined using the connection capability included in the traffic descriptor. More specifically, assuming that (A) connection capability is 8-bit information, this may have values ranging from 0 to 255, and some values of (A) may be assigned as values for (B) traffic categories, wherein one of (B) may be designated as “Enterprise,” another as “Gaming,”, another as “Video Streaming,” etc.

According to an embodiment of the disclosure, the information that categorizes a specific application as a specific traffic category may be predefined as a standard and configured in the UE and/or a network entity, or may be delivered through communication between network entities or between the UE and the network. For example, an AF, a PCF, and a UE may each store information about which application can be mapped to which traffic category. As a more specific example, the AF, the PCF, and the UE may each store information indicating that application #1 and application #3 may be mapped to traffic category #1, and application #2 may be mapped to traffic category #2. In requesting the storage, update, deletion, etc. of a UE policy and related information, the AF, the PCF, and/or the UE may each request the storage, update, deletion, etc. of UE policy and related information for a specific traffic category, or may request the storage, update, deletion, etc. of UE policy and related information an application included in a specific traffic category. For example, when the AF wishes to provide the core network with a request related to the determination of URSP rules for all applications corresponding to a specific traffic category, the AF may provide the traffic category and request information to the PCF via an NEF or a UDR.

According to an embodiment of the disclosure, when the PCF receives, from a UDR, AF, or other NF, a request or information that relates to the determination of URSP rules for all applications in a specific traffic category, the PCF may apply the information to all URSP rules for the traffic category to determine URSP rules. After the PCF may determine the URSP rules using the traffic category, and then may transmit the URSP rules to the UE. The UE's NAS controller may deliver the received URSP rules using the traffic category to the URSP handler. When a specific traffic category value is received from a traffic classifier, the URSP handler may specify a URSP rule that matches the specific traffic category value. If there is one or more URSP rules matching the traffic category, the URSP handler may further consider information other than the traffic category received from the OS (e.g., application ID or FQDN may be included) to specify one URSP rule, and if there is no such information, the URSP handler may specify one URSP rule with a high rule precedence.

The operating system may operate in an application Processor. The OS may include a traffic classifier. When an application is executed to generate data traffic, the traffic classifier may deliver direct or indirect identification information of the application to the URSP handler. The URSP handler may provide the URSP handler with information other than the application ID as identification information of the application. For example, the URSP handler may provide a traffic category value of any application to the URSP handler.

The application layer may be located above the OS. Applications may exist in the application layer. When an application is executed and generates data traffic, the application traffic may be delivered to the OS. Furthermore, an application ID may be provided to the traffic classifier to identify which application generated the application traffic.

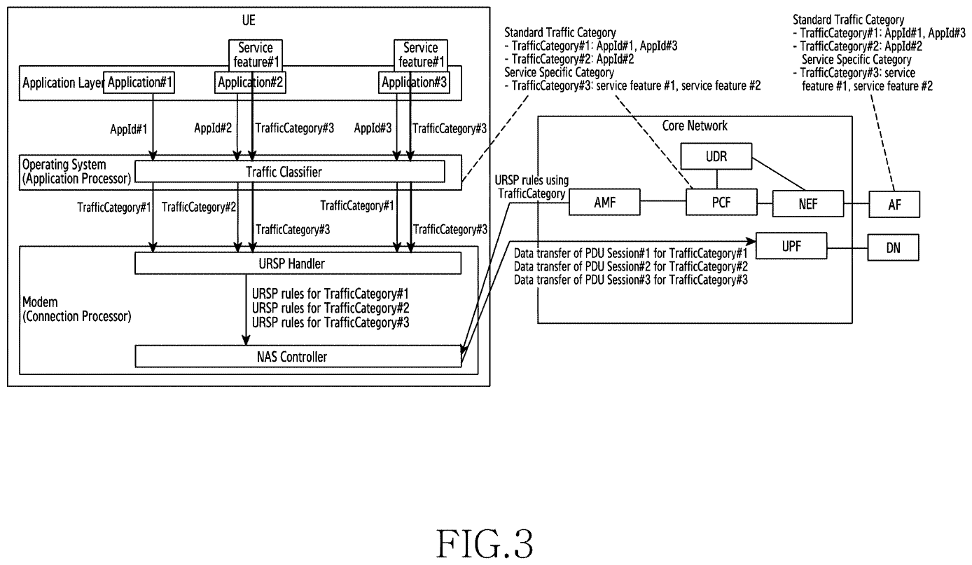

FIG. 3 illustrates a network architecture and an interface of a 5G system according to an embodiment of the disclosure. FIG. 3 includes a UE policy processing procedure, in the system described in FIG. 2, in which an application in a UE provides indirect identification information of the application to a layer below an OS through the OS. The description of FIGS. 1 and 2 may be omitted from the description of FIG. 3.

According to an embodiment of the disclosure, information categorizing a specific application into a specific traffic category may be predefined as a standard and configured in the UE and/or a network entity, may be newly configured in the UE and/or the network entity by a decision and request of the network entity, or may be delivered through communication between network entities or between the UE and a network.

For example, an AF, a PCF, and the UE may each store information about which application can be mapped to which traffic category (hereinafter, standard traffic categories), and the AF may assign a service-specific traffic category to an application that uses a certain service function (hereinafter, service-specific traffic category) and may provide the same to the PCF and/or the UE.

As a more specific example, the AF, the PCF, and the UE may each store information indicating that application #1 and application #3 may be mapped to traffic category #1, and application #2 may be mapped to traffic category #2. In this case, the mapping information stored in the AF, the PCF, and the UE may all be the same, and traffic categories #1 and #2 correspond to standard traffic categories. The AF may map service feature #1 and service feature #2 to traffic category #3 according to the decision of a service manager managing the AF, and provide necessary information when determining a URSP rule for traffic category #3. In this case, traffic category #3 corresponds to a service-specific traffic category. Functions provided only to premium subscribers (4K video transmission, paid features, etc.) may be examples of service features.

The service manager may specify a service-specific traffic category for the same application when the service manager want to transmit application traffic generated from a specific service function to a separate PDU session or a separate network slice. The PCF may determine the URSP rule, based on information about the service functions mapped to traffic category #3 received from the AF via NEF or via NEF and UDR and information required when determining the URSP rule for traffic category #3, and the determined URSP rule may be provided to the UE. A URSP handler of the UE may store the URSP rule that includes traffic category #3. Additionally, the URSP handler may provide, to a traffic classifier, an indication (hereinafter, transparent TC indication) requesting that a request for application data traffic transmission for traffic category #3, which may be generated directly by an application, be transparently delivered to the URSP handler without any processing/mapping in the OS. When a service function (service feature #1 in FIG. 3) that is mapped to a service-specific traffic category is executed in an application, application traffic generated from the function may be distinguished from other application traffic generated from the application, and traffic category #3 may be provided to the traffic classifier in place of an application ID to recognize that the application traffic is generated from the service function that is mapped to traffic category #3.

The service-specific traffic category may be provided as a piece of information that constitutes a traffic descriptor or a route selection component of a URSP rule. For example, as illustrated in FIG. 2, a traffic category may be defined using a connection capability included in the information in the traffic descriptor. More specifically, assuming that (A) connection capabilities are 8-bit information, these may have values ranging from 0 to 255, and some of (A) may be assigned as values for (B) standard traffic categories, wherein one of (B) may be designated as “Enterprise,” another as “Gaming,” another as “Video Streaming,” etc. Others of the connection capabilities may be assigned as values for (C) service-specific traffic categories. Referring to FIG. 3, traffic category #1 and traffic category #2 may correspond to standard traffic categories, and traffic category #3 may correspond to a service-specific traffic category.

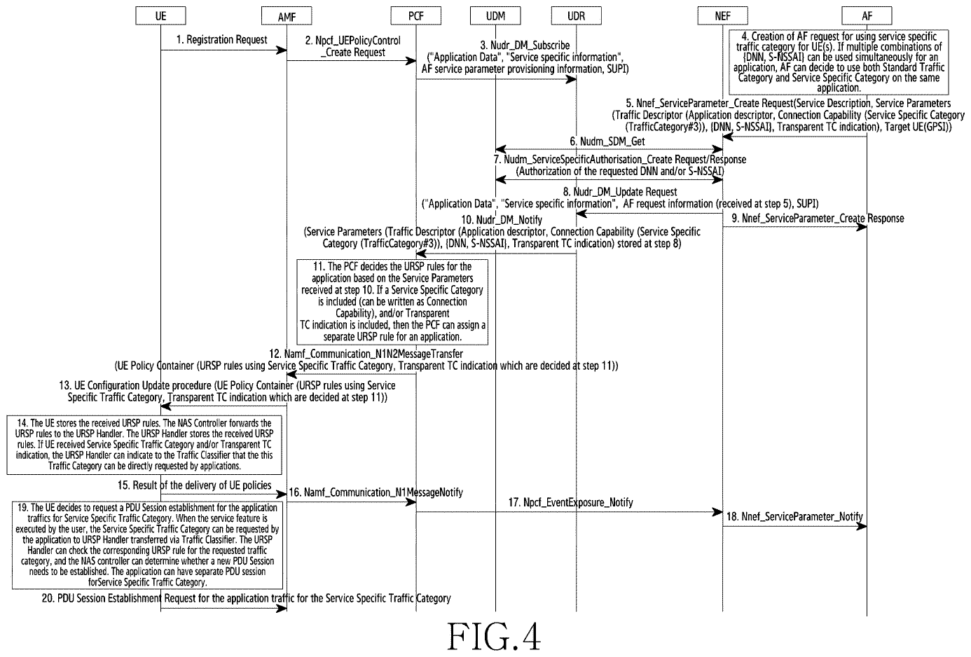

FIG. 4 illustrates a procedure for delivering and processing a UE policy in a 5G system according to an embodiment of the disclosure. FIG. 4 includes the description of FIGS. 1 to 3, which may be omitted from the description of FIG. 4.
In step 1, a UE may transmit a registration request to an AMF.
In step 2, the AMF may request UE association establishment from a PCF. At this point, an Npcf_UEPolicyControl_Create request may be transmitted.
In step 3, the PCF may request a UDR to notify of any changes in information related to UE policy data. In requesting the UDR to notify the information, the PCF may use an Nudr_DM_Subscribe message and may provide “application data” as a data set value, “service-specific information” as a data subset value, and SUPI as a UE identifier. The service-specific information may include information indicating that the UDR is requested to notify of whether any changes related to a service parameter provisioning information have occurred.
In step 4, an AF may generate a request related to the UE's use of a service-specific category. For example, the AF may generate a request that allows one or more PDU sessions, i.e., combinations of one or more DNNs and S-NSSAIs, to be used simultaneously for one application. More specifically, the AF may generate a request to enable simultaneous use of a PDU session using a standard traffic category and a PDU session using a service-specific traffic category for one application.
In step 5, for the UE's use of the service-specific traffic category, the AF may transmit a request including relevant information required for URSP rule determination to an NEF. The AF may use a Nnef_ServiceParameter_Create request message, which may include at least one of a service description and service parameters. The service parameters may include at least one of a traffic descriptor and a target UE as information required for URSP rule determination. The traffic descriptor may include at least one among an application descriptor, connection capability, DNN, S-NSSAI, and a transparent TC indication. A service-specific traffic category (traffic category #3 in the present embodiment) that is to be requested by the AF may be provided as connection capability. The data network name (DNN) and the S-NSSAI corresponds to the DNN and the S-NSSAI assigned to a PDU session for the requested service-specific traffic category. The service-specific traffic category may be provided as another piece of information in the traffic descriptor, other than the connection capability. In FIG. 4, a description is made based on the case where the service-specific traffic category is provided as a value of connection capability. However, the disclosure is not limited thereto. The target UE may include a generic public subscription identifier (GPSI).
In step 6, the NEF may request and receive, from UDM, information required for mapping the GPSI to a subscription permanent identifier (SUPI). A Nudm SDM_Get message may be used.
In step 7, the NEF may request the UDM to determine whether the AF was allowed to make a request related to the URSP rule determination for the DNN and/or S-NSSAI included in the request in step 5, with respect to the target UE included in the request in step 5.

The NEF may transmit a Nudm_ServiceSpecificAuthorization Create request message to the UDM, and may provide the DNN and/or the S-NSSAI included in the request in step 5. The UDM may transmit a Nudm_ServiceSpecificAuthorisation_Create response message to the NEF. Through the Nudm_ServiceSpecificAuthorisation_Create response message, the NEF may determine whether the requested DNN and/or S-NSSAI is a DNN to which the UE is allowed to be connected and/or S-NSSAI to which the UE is allowed to be connected, based on subscriber information stored in the UDM, and may provide the result of the determination. As a result of step 7, when it is determined that the connection is allowed, the NEF may continue with the procedures following step 7.
In step 8, the NEF may deliver, to the UDR, the request information received from the AF in step 5. In providing the information to the UDR, the NEF may use an Nudr_DM_Update request message and may provide “application data” as a data set value, “service-specific information” as a data subset value, and SUPI as a UE identifier. The service-specific information may be provided with the request information received from the AF in step 5 and the SUPI. The request information received from the AF may include at least one of a service-specific traffic category (traffic category #3 in the present embodiment) that is to be requested by the AF, DNN and/or S-NSSAI assigned to a PDU session therefor, and a transparent TC indication.
In step 9, the NEF may respond to the AF with the result of the AF's request in step 5.
In step 10, the UDR may recognize the information in step 8 as a change related to service parameter provisioning information of a UE using the SUPI, and may notify the PCF of the change. The UDR may use an Nudr_DM Notify message and may provide service parameters received and stored in step 8. The service parameters may include at least one among the service-specific traffic category (traffic category #3 in the present embodiment) that is to be requested by the AF, the DNN and/or S-NSSAI assigned to the PDU session therefor, and the transparent TC indication, received in step 8.
In step 11, the PCF may determine, based on the information received in step 10, a URSP rule using the service-specific traffic category. When the PCF receives a traffic category and/or a transparent TC Indication with an assigned value for the service-specific traffic category, the PCF may assign one or more URSP rules to the same application. URSP rules assigned to one application may be distinguished by being given different rule precedence values. Also, even when URSP rules assigned for one application are given the same rule precedence value, the URSP rules may be distinguished as different URSP rules if traffic categories specified in the URSP rules correspond to service-specific traffic categories and traffic category values of the URSP rules are different.
In step 12, the PCF may transmit, to the AMF, a UE policy container containing the URSP rules using the service-specific traffic category determined in step 11. The PCF may further include a transparent UE TC indication in the UE policy container. The UE policy container is information that cannot be opened by the AMF and may be transparently provided to the UE.
In step 13, the AMF may deliver, to the UE, the UE policy container received in step 12.
In step 14, the UE may store and process the received URSP rule. As described in FIGS. 2 and 3, the NAS controller may deliver the URSP rule to the URSP handler. The URSP handler may store the URSP rule. When the URSP handler receives a service-specific traffic category or both a service-specific traffic category and transparent TC indication, the URSP handler may inform the traffic classifier that the service-specific traffic category may be requested directly from the application.
In step 15, the UE may inform the AMF of the result of UE policy transmission.
In step 16, the AMF may inform the PCF of the result of the UE policy transmission.
In step 17, the PCF may notify the NEF that service parameter transmission has occurred.
In step 18, the NEF may notify the AF that the service parameter transmission has occurred.
In step 19, when application traffic mapped to the service-specific traffic category occurs, the UE may determine whether PDU session establishment therefor is required. For example, if a user has executed a service feature that is mapped to a service-specific traffic category, as described in FIGS. 2 and 3, an application may provide the service-specific traffic category value to the traffic classifier, and the traffic classifier may deliver the value to the URSP handler without any processing. The URSP handler may specify a URSP rule that is mapped to the service-specific traffic category, and may determine whether a PDU session already exists for the URSP rule or whether a new PDU session needs to be established. As a result of step 19, one application may establish a separate PDU session for the service-specific traffic category, and thus may use one or more PDU sessions simultaneously.
In step 20, the UE may request to establish a new PDU session for the service-specific traffic category, based on the determination in step 19.

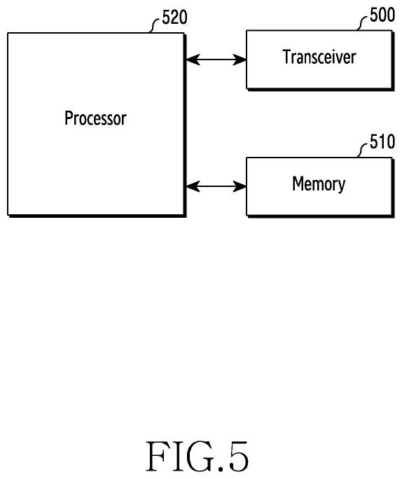

FIG. 5 is a block diagram illustrating a structure of a UE according to an embodiment of the disclosure.

As illustrated in FIG. 5, a UE of the disclosure may include a processor 520, a transceiver 500, and a memory 510. However, components of the UE are not limited to the above-described example. For example, the UE may include a larger or smaller number of components than the above-described components. In addition, the processor 520, the transceiver 500, and the memory 510 may be implemented in the form of a single chip.

According to an embodiment of the disclosure, the processor 520 may control a series of processes so that the UE can operate according to the above-described embodiments of the disclosure. For example, the processor 520 may control the components of the UE in order to perform the methods for providing broadcast services according to the above-described embodiments. The processor 520 may control the components of the UE to perform the above-described embodiments of the disclosure by executing the programs stored in the memory 510. In addition, the processor 520 may be an application processor (AP), a communication processor (CP), a circuit, an application-specific circuit, or at least one processor.

According to an embodiment of the disclosure, the transceiver 500 may transmit/receive signals with network entities, other UEs, or base stations. The signals transmitted/received with network entities, other UEs, or base stations may include control information and data. The transceiver 500 may include an RF transmitter configured to up-convert and amplify the frequency of transmitted signals, an RF receiver configured to low-noise-amplify received signals and down-convert the frequency thereof, and the like. However, this is only an embodiment of the transceiver 500, and the components of the transceiver 500 are not limited to the RF transmitter and the RF receiver. In addition, the transceiver 500 may receive signals through a radio channel, output the same to the processor 520, and transmit signals output from the processor 520 through the radio channel.

According to an embodiment of the disclosure, the memory 510 may store programs and data necessary for operations of the UE. In addition, the memory 510 may store control information or data included in signals transmitted/received by the UE. The memory 510 may include storage media such as a ROM, a RAM, a hard disk, a CD-ROM, and a DVD, or a combination of storage media. In addition, the memory 510 may include multiple memories. Furthermore, according to an embodiment, the memory 510 may store programs for executing the above-described methods for providing UE policies.

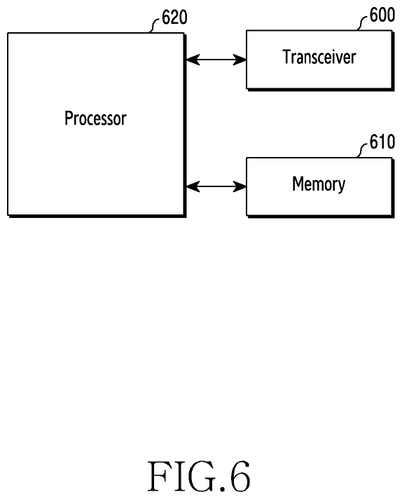

FIG. 6 is a block diagram illustrating a structure of a base station according to an embodiment of the disclosure.

As illustrated in FIG. 6, a base station of the disclosure may include a processor 620, a transceiver 600, and a memory 610. However, components of the base station are not limited to the above-described example. For example, the base station may include a larger or smaller number of components than the above-described components. In addition, the processor 620, the transceiver 600, and the memory 610 may be implemented in the form of a single chip.

According to an embodiment of the disclosure, the processor 620 may control a series of processes so that the base station can operate according to the above-described embodiments of the disclosure. For example, the processor 620 may control the components of the base station to perform the methods for providing UE policies according to the above-described embodiments. The processor 620 may control the components of the base station to perform the embodiments of the disclosure by executing the programs stored in the memory 610. In addition, the processor 620 may be an application processor (AP), a communication processor (CP), a circuit, an application-specific circuit, or at least one processor.

According to an embodiment of the disclosure, the transceiver 600 may transmit/receive signals with network entities, other base stations, or UEs. The signals transmitted/received with network entities, other base stations, or UEs may include control information and data. The transceiver 600 may include an RF transmitter configured to up-convert and amplify the frequency of transmitted signals, an RF receiver configured to low-noise-amplify received signals and down-convert the frequency thereof, and the like. However, this is only an embodiment of the transceiver 600, and the components of the transceiver 600 are not limited to the RF transmitter and the RF receiver. In addition, the transceiver 600 may receive signals through a radio channel, output the same to the processor 620, and transmit signals output from the processor 620 through the radio channel.

According to an embodiment of the disclosure, the memory 610 may store programs and data necessary for operations of the base station. In addition, the memory 610 may store control information or data included in signals transmitted/received by the base station. The memory 610 may include storage media such as a ROM, a RAM, a hard disk, a CD-ROM, and a DVD, or a combination of storage media. In addition, the memory 610 may include multiple memories. Furthermore, according to an embodiment, the memory 610 may store programs for executing the above-described methods for providing UE policies.

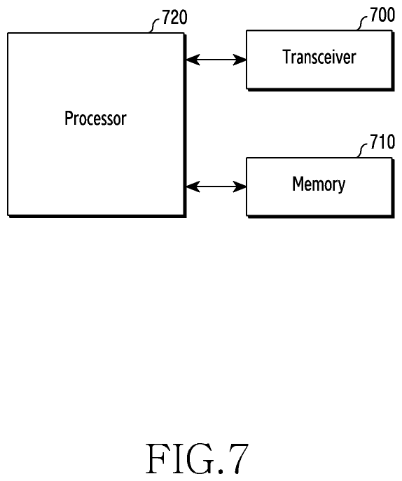

FIG. 7 is a block diagram illustrating a structure of a network entity according to an embodiment of the disclosure.

As illustrated in FIG. 7, a network entity of the disclosure may include a processor 720, a transceiver 700, and a memory 710. However, components of the network entity are not limited to the above-described example. For example, the network entity may include a larger or smaller number of components than the above-described components. In addition, the processor 720, the transceiver 700, and the memory 710 may be implemented in the form of a single chip. Furthermore, according to an embodiment of the disclosure, the network entity may refer to a network function (NF), and the NF may include an RAN, an AMF, a PCF, a UDM, an AF, an NEF, a UTM, etc.

According to an embodiment of the disclosure, the processor 720 may control a series of processes so that the NF can operate according to the above-described embodiments of the disclosure. For example, the processor 720 may control the components of the network entity in order to perform the methods for providing UE policies according to the above-described embodiments. The processor 720 may control the components of the network entity to perform the embodiments of the disclosure by executing the programs stored in the memory 710. In addition, the processor 720 may be an application processor (AP), a communication processor (CP), a circuit, an application-specific circuit, or at least one processor.

According to an embodiment of the disclosure, the transceiver 700 may transmit/receive signals with other network entities, base stations, or UEs. The signals transmitted/received with other network entities or UEs may include control information and data. The transceiver 700 may include an RF transmitter configured to up-convert and amplify the frequency of transmitted signals, an RF receiver configured to low-noise-amplify received signals and down-convert the frequency thereof, and the like. However, this is only an embodiment of the transceiver 700, and the components of the transceiver 700 are not limited to the RF transmitter and the RF receiver. In addition, the transceiver 700 may receive signals through a radio channel, output the same to the processor 720, and transmit signals output from the processor 720 through the radio channel.

According to an embodiment of the disclosure, the memory 710 may store programs and data necessary for operations of the network entity. In addition, the memory 710 may store control information or data included in signals transmitted/received by the network entity. The memory 710 may include storage media such as a ROM, a RAM, a hard disk, a CD-ROM, and a DVD, or a combination of storage media. In addition, the memory 710 may include multiple memories. Furthermore, according to an embodiment, the memory 710 may store programs for executing the above-described methods for providing UE policies.

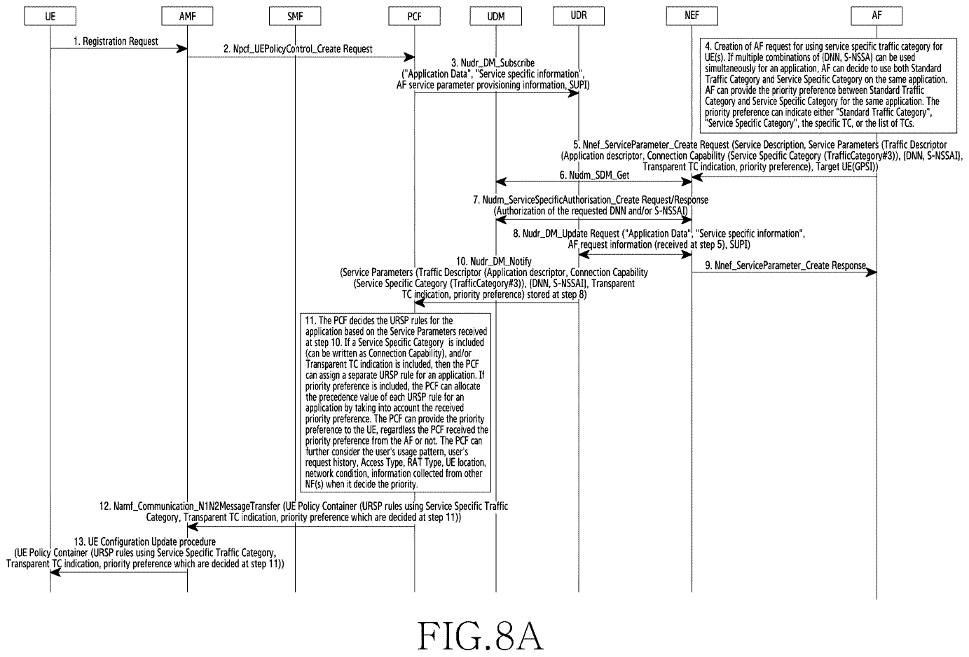

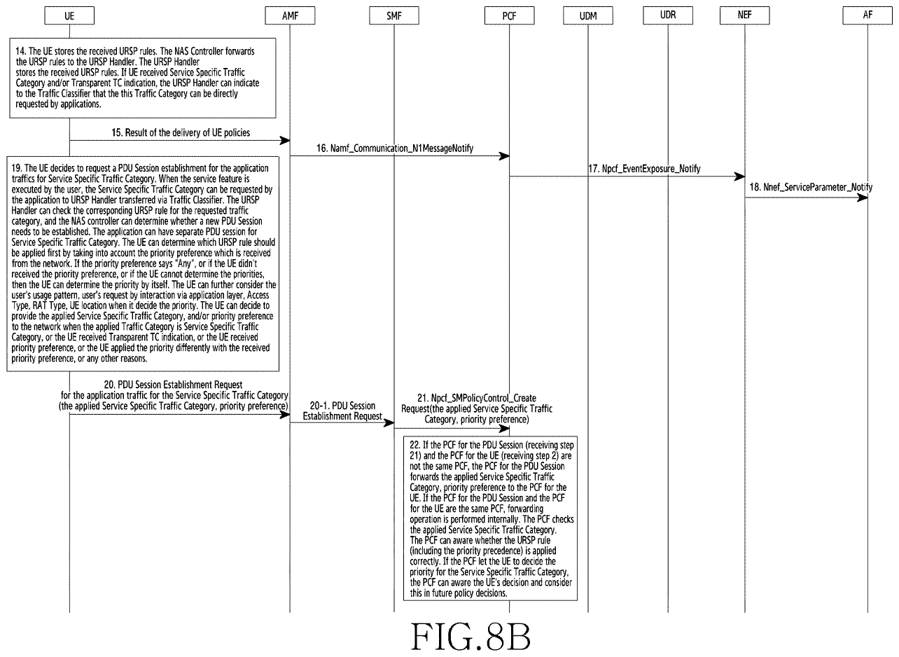

FIGS. 8A and 8B illustrate a procedure for delivering and processing a UE policy in a 5G system according to an embodiment of the disclosure. Referring to the description of FIG. 4, when a traffic category and/or transparent TC indication with a value assigned for a service-specific traffic category is received, the PCF may assign one or more URSP rules to one application. For example, URSP rules for one application may be distinguished by being given different rule precedence values. Also, even when the same rule precedence value is used for URSP rules assigned for one application, the URSP rules may be distinguished as different URSP rules if the traffic categories specified in the URSP rules correspond to service-specific traffic categories and the traffic category values of the URSP rules are different.

In FIG. 4, based on the rule precedence value, traffic category value, and/or transparent TC indication, the priority between a standard traffic category and a service-specific traffic category may be distinguished.

FIGS. 8A and 8B illustrate a method by which an AF, a PCF, and/or a UE may determine, deliver, and request a priority between a standard traffic category and a service-specific traffic category. In distinguishing the priority between traffic categories, embodiments of the disclosure may not only distinguish the priority between a standard traffic category and a service-specific traffic category, but may also distinguish the priority between traffic categories having different values, even within the same standard traffic categories or the same service-specific traffic categories. In describing FIGS. 8A and 8B, a description overlapping that of FIG. 4 may be omitted.

In step 4, when one or more traffic categories are applied to one application (including the case in which one or more standard traffic categories and one or more service-specific traffic categories are applied to one application), the AF may provide information about the priority among the traffic categories (hereinafter, “priority preference”). For example, the AF may provide, as the priority preference, a traffic category that should be applied with higher priority between the standard traffic category and the service-specific category (if a URSP rule using the service-specific category should be applied with higher priority, the AF may provide “service-specific category” as a priority preference value).

In various embodiments, the AF may provide, as a priority preference, the value of the traffic category that should be applied with higher priority. For example, if traffic category #3 should be applied the highest priority, the AF may provide “traffic category #3” as a priority preference value. In this case, since traffic category #3 is a specific traffic category, the AF may request that traffic category #3 should be applied the highest priority, or may request that traffic category #3 should be applied with higher priority than other standard categories or specific traffic categories.

In various embodiments, the AF may set a priority between one or more traffic categories and provide the same as a priority preference value. For example, if the priority order is traffic category #3, traffic category #1, and traffic category #2, the AF may provide a list in the order of traffic category #3, traffic category #1, and traffic category #2 as the priority preference value.

In various embodiments, when the AF chooses to follow the priority determination made by the network or the UE, the AF may provide “Any” as a priority preference value.

In various embodiments, the AF may request the PCF to report the result determined by the network or the UE. This request may be made using a policy control trigger request.

A priority preference according to embodiments of the disclosure may be a request for a specific application, specific applications, or a group of applications, a request for a specific UE, UEs, or a group of UEs, or a request for the priority between traffic categories, regardless of an application and/or a UE. When the AF requests a priority preference by specifying an application (group) and/or a UE (group), the AF may provide, together with the request, an indicator (e.g., application ID or UE ID) that allows the application (group) and/or the UE (group) to be specified.

The priority preference value provided by the AF in step 4 may be provided to the PCF in step 5, step 8, and step 10, and may be stored in the UDR in step 8. When an application and/or a UE to which the priority preference is to be applied is specified, a corresponding indicator may be provided together and stored.

In step 11, when the PCF has received the priority preference from the AF through steps 4, 5, 8, and 10, the PCF may determine, based on the priority preference value, whether a URSP rule to which a certain traffic category is applied with respect to one application has a higher priority. Furthermore, the PCF may assign a rule precedence value to the URSP rule accordingly. Even when the PCF have or have not received the priority preference from the AF, the PCF may refer to other information. The other information may include at least one among a user's traffic usage pattern, the user's communication request history, access type, RAT type, UE's location information, network conditions (e.g., network congestion, network delay, or network error rate), information collected from other NFs (e.g., information collected via NWDAF), PCF configuration information, and an operator's QoS management and charging schemes. For example, when the PCF has received “service-specific category” as a priority preference value from the AF and may determine that traffic category #3 corresponds to a service-specific traffic category, the PCF may determine a rule precedence value for a URSP rule to which traffic category #3 is applied is higher than those of other URSP rules.

In various embodiments, when the PCF has received “Any” as a priority preference value from the AF or has not received the priority preference from the AF, the PCF may determine that the QoS of traffic corresponding to the service-specific traffic category should be independently ensured and charging should be recorded, according to the QoS management and charging scheme of the operator, and thus may autonomously determine the priority preference value to be “service-specific traffic category.” In other words, based on various pieces of information, the PCF may determine the priority preference and determine the rule precedence values of the URSP rules.

In various embodiments, when the PCF is requested by the AF to report the result determined by the network or the UE, the PCF may deliver, to the AF, information (priority preference) about the priority of the traffic category determined by the PCF.

In various embodiments, when the PCF recognizes that the UE has applied a service-specific traffic category, or recognizes information (priority preference) about the priority of a traffic category applied by the UE, the PCF may request the SMF to report the traffic category information and/or the information about the priority of the traffic category. This request may be made using a policy control trigger request.

In step 12, the PCF may deliver a UE policy container containing the priority preference determined in step 11 (which may be identical to or different from the information received from the AF in step 10) to an AMF.

In step 13, the AMF may deliver, to the UE, the UE policy container containing the priority preference and received in step 12.

In step 16, when the PCF has been requested by the AF to report the result determined by the network or the UE and has been notified by the UE that the UE policy transmission was successfully performed, the PCF may deliver, to the AF, information (priority preference) about the priority preference of the traffic category determined by the PCF.

In step 19, the UE may determine to establish a separate PDU session for the transmission of traffic corresponding to a service-specific traffic category (a PDU session different from a PDU session for the transmission of traffic corresponding to another traffic category, or a standard traffic category) for one application. When one or more traffic categories are assigned to the application (this may include the case wherein one or more standard traffic categories and one or more service-specific traffic categories are applied to one application), the UE may determine which URSP rule to apply with priority, based on the priority preference value received in step 13. Even when the priority preference has been received or has not been received from the network, the UE may refer to other information. The other information may include at least one among: a user's traffic usage pattern, the user's communication request history, access type, RAT type, location information of the UE, information collected from the network (e.g., information collected via NWDAF), UE configuration information, and the operator's QoS management and charging scheme. For example, referring to FIG. 3, if the UE has simultaneously received, via the traffic classifier, notifications that traffic corresponding to traffic category #2 and traffic corresponding to traffic category #3 have occurred, and if the UE may determine, from the priority preference value received in step 13, that the service-specific category has a higher priority, and may determine that traffic category #3 corresponds to a service-specific traffic category (e.g., if a transparent TC indication is received with traffic category #3 information), the UE may apply a URSP rule to which traffic category #3 is applied, before a URSP rule to which traffic category #1 is applied, to determine the establishment of PDU session #1 for the traffic and perform the procedure after step 20 for establishing PDU session #1.

In various embodiments, if the UE has simultaneously received, via the traffic classifier, notifications that traffic corresponding to traffic category #2 and traffic corresponding to traffic category #3 have occurred, and if the UE may determine that traffic category #3 corresponds to a service-specific traffic category (e.g., when a transparent TC indication has been received with traffic category #3 information), even if the UE has received “Any” as the priority preference value in step 13, or has not received any priority preference, the UE may determine, based on the user's traffic usage pattern, that it is appropriate for the traffic corresponding to the service-specific traffic category to be managed with independent QoS, regardless of the application, and accordingly, the UE may autonomously determine the preference value to be “service-specific traffic category.”

In various embodiments, when the UE has simultaneously received, via the traffic classifier, notifications that traffic corresponding to traffic category #2 and traffic corresponding to traffic category #3 have occurred, and when the UE has received “Any” as a priority preference value or has not received any priority preference, the UE may determine that the value of a traffic category of a URSP rule with higher rule precedence, among URSP rule to which traffic category #2 has been applied and URSP rules to which traffic category #3 has been applied, corresponds to a priority preference value.

In various embodiments, when the UE may have simultaneously received, via the traffic classifier, notification that traffic corresponding to category #2 and traffic corresponding to category #3 have occurred, and may determine that traffic category #3 corresponds to a service-specific traffic category (e.g., when a transparent TC indication has been received with traffic category #3 information), when a URSP rule to which traffic category #2 has been applied and a URSP rule to which traffic category #3 has been applied have are the same rule precedence, and when “Any” has been received as a priority preference value or no priority preference has been received, the UE may autonomously determine the preference value to be “service-specific traffic category”, based on the other information described above.

In various embodiments, when the UE has simultaneously received, via the traffic classifier, that traffic corresponding to traffic category #2 and traffic corresponding to traffic category #3 have occurred, and may determine that traffic category #3 corresponds to a service-specific traffic category (e.g., when a transparent TC indication has been received with traffic category #3 information), and when a URSP rule to which traffic category #2 has been applied and a URSP rule to which traffic category #3 are identical, except for the traffic category value (this may include the case wherein even a combination of a rule precedence value, DNN, and S-NSSAI is identical) and thus the UE may not determine the priority between the URSP rules, the UE may autonomously determine a preference value to be “service-specific traffic category” by referring to the other information described above.

When requesting the establishment/modification of a PDU session, the UE may determine whether to report, to the network, at least one of: a traffic category applied to the PDU session; and a priority preference value applied by the UE. For example, in one of the cases in which: the UE has applied a service-specific traffic category; the UE has received a transparent TC indication; the UE has received priority preference; the UE has not received a priority preference value but has applied a service-specific traffic category; and the UE has applied a determination different from a received priority preference value (e.g., when the UE has received “Any” but autonomously determined the preference value to be a “service-specific traffic category”), the UE may determine to report, to the network, the traffic category applied by the UE and/or the priority preference applied by the UE.

In step 20, when transmitting the PDU session establishment/modification request to the network, the UE may provide the traffic category applied by the UE and/or the priority preference applied by the UE, based on the determination in step 19. This message may be delivered to the SMF via the AMF in step 20-1.

In step 21, the SMF may deliver the traffic category applied by the UE and/or the priority preference applied by the UE, received in step 20-1, to a PCF responsible for session management. In this case, an Npcf_SMPolicyControl_Create request message may be used.

In various embodiments, when the SMF recognizes that the UE has applied a service-specific traffic category, or recognizes information (priority preference) about the priority of the traffic category applied by the UE, and when the SMF has been requested by the PCF to report the traffic category information and/or the information about the priority of the traffic category, the SMF may deliver the information to the PCF.

In step 22, the PCF responsible for session management may deliver the traffic category applied by the UE and/or the priority preference applied by the UE, received in step 21, to a PCF responsible for a UE policy. In this case, an Npcf_UEPolicyControl_Create request message may be used. If the PCF responsible for session management and the PCF responsible for a UE policy is the same PCF, the delivering of the traffic category applied by the UE and/or the priority preference applied by the UE may be performed internally in the PCF. The PCF may identify the service-specific traffic category applied by the UE, and may identify whether the PDF complies with the UE policy established by the PCF. If the PCF has requested the UE to determine a priority preference (“Any”), the PCF may identify how the UE has determined the priority of a traffic category. When the PCF has been requested by the AF to report the result determined by the network or the UE, the PCF may deliver, to the AF, the information about the priority of the traffic category determined by the UE.

In various embodiments, when the priority of a traffic category is determined by the PCF or the UE, as well as other network entities, the PCF may deliver information about the priority to the AF.

It should be noted that the configuration diagrams, illustrative diagrams of control/data signal transmission methods, and illustrative diagrams of operation procedures as illustrated in FIG. 1 to FIG. 8 are not intended to limit the scope of protection of the disclosure. That is, all the constituent elements, entities, or operation steps shown and described in FIG. 1 to FIG. 8 should not be construed as being essential elements for the implementation of the disclosure, and even when including only some of the elements, the disclosure may be implemented without impairing the true of the disclosure.

The above-described operations of the embodiments may be implemented by providing any unit of a device with a memory device storing corresponding program codes. That is, a controller in the device may perform the above-described operations by reading and executing the program codes stored in the memory device by means of a processor or central processing unit (CPU).

Various units or modules of an entity or terminal device set forth herein may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely particular examples that have been presented to easily explain the technical contents of the disclosure and help understanding of the disclosure, and are not intended to limit the scope of the disclosure. Therefore, the scope of various embodiments of the disclosure should be construed to include, in addition to the embodiments set forth herein, all changes and modifications derived based on the technical idea of various embodiments of the disclosure. Also, the above respective embodiments may be employed in combination, as necessary.

1. A method performed by a user equipment (UE) in a wireless system, the method comprising:
obtaining a UE policy container comprising UE route selection policy (URSP) rules determined by a policy control function (PCF);
storing the UE route selection policy rules (URSP rules);
based on a traffic category of application traffic, identifying at least one UE route selection rule from among the UE route selection rules; and
based on the at least one UE route selection rule, establishing a protocol data unit session for transmitting the application traffic,
wherein the at least one UE route selection policy rule is determined based on the traffic category of the application traffic.

2. The method of claim 1, wherein the at least one UE route selection policy rule comprises a traffic descriptor for identifying application traffic, and the traffic descriptor comprises a connection capability field for indicating the traffic category.

3. The method of claim 1, wherein the at least one UE route selection policy rule comprises a service traffic category for identifying service traffic based on a specific service function,
wherein the identifying of the at least one UE route selection rule comprises identifying the at least one UE route selection rule, based on a service traffic category of an application, and
wherein the establishing of the protocol data unit session comprises establishing a protocol data unit session for transmitting the service traffic, based on the at least one UE route selection rule.

4. The method of claim 1, wherein each of the UE route selection rules comprises information about priority, and
wherein the identifying of the at least one UE route selection rule is based on the information about priority.

5. A user equipment (UE) in a wireless system, the UE comprising:
a transceiver; and
a processor connected to the transceiver,
wherein the processor is configured to:
obtain a UE policy container comprising UE route selection policy (URSP) rules determined by a policy control function (PCF);
store the UE route selection policy rules (URSP rules);
based on a traffic category of application traffic, identify at least one UE route selection rule from among the UE route selection rules; and
based on the at least one UE route selection rule, establish a protocol data unit session for transmitting the application traffic, and
wherein the at least one UE route selection policy rule is determined based on the traffic category of the application traffic.

6. The UE of claim 5, wherein the at least one UE route selection policy rule comprises a traffic descriptor for identifying application traffic, and the traffic descriptor comprises a connection capability field for indicating the traffic category.

7. The UE of claim 5, wherein the at least one UE route selection policy rule comprises a service traffic category for identifying service traffic based on a specific service function, and
wherein the processor is configured to:
identify the at least one UE route selection rule, based on a service traffic category of an application; and
establish a protocol data unit session for transmitting the service traffic, based on the at least one UE route selection rule.

8. The UE of claim 5, wherein each of the UE route selection rules comprises information about priority, and
wherein the processor is configured to identify the at least one UE route selection rule, based on the information about priority.

9. A method performed by a policy control function (PCF) in a wireless system, the method comprising:
receiving information related to a traffic category corresponding to application traffic and a protocol data unit session for the application traffic;
based on the traffic category, determining a UE route selection policy (URSP) rule for the application traffic; and
transmitting, to a user equipment (UE), a UE policy container comprising the UE route selection policy rule.

10. The method of claim 9, wherein the UE route selection policy comprises a traffic descriptor for identifying application traffic, and the traffic descriptor comprises a connection capability field for indicating the traffic category.

11. The method of claim 9, wherein the receiving comprises receiving information related to a service traffic category for identifying service traffic based on a specific service function and a protocol data unit session for the service traffic, and
wherein the determining comprises determining a UE route selection policy (URSP) rule for the service traffic, based on the service traffic category.

12. The method of claim 9, wherein the UE route selection rule comprises information about priority.

13. A policy control function (PCF) in a wireless system, the PCF comprising:
a transceiver; and
a processor connected to the transceiver,
wherein the processor is configured to:
receive information related to a traffic category corresponding to application traffic and a protocol data unit session for the application traffic;
based on the traffic category, determine a UE route selection policy (URSP) rule for the application traffic; and
transmit, to a user equipment (UE), a UE policy container comprising the UE route selection policy rule.

14. The PCF of claim 13, wherein the UE route selection policy comprises a traffic descriptor for identifying application traffic, and the traffic descriptor comprises a connection capability field for indicating the traffic category.

15. The PCF of claim 13, wherein the processor is configured to:
receive information related to a service traffic category for identifying service traffic based on a specific service function and a protocol data unit session for the service traffic; and
based on the service traffic category, determine a UE route selection policy (URSP) rule for the service traffic.
